(19) United States
(12) Patent Application Publication
(10) Pub. No.: US 2013/0256269 A1
(43) Pub. Date: Oct. 3, 2013

(54) METHODS AND APPARATUS FOR MODIFYING SURFACE ENERGY OF LAMINATE STACK UP

(71) Applicant: Michael M. NIKKHOO, San Jose, CA (US)

(72) Inventor: Michael M. NIKKHOO, San Jose, CA (US)

(73) Assignee: Apple Inc., Cupertino, CA (US)

(21) Appl. No.: 13/631,809

(22) Filed: Sep. 28, 2012

Related U.S. Application Data
(60) Provisional application No. 61/617,430, filed on Mar. 29, 2012.

(51) Int. Cl. B01J 19/08; B05C 11/00; B08B 7/00; B44C 1/22

(52) U.S. Cl. 216/67; 156/345.33; 156/345.26; 134/1.1

(57) ABSTRACT

The described embodiments relate generally to the manufacturing of consumer electronics and computing devices, and more particularly to providing mechanisms that modify the surface energy of a substrate to facilitate the forming of a bond between disparate materials. In one embodiment, the surface energy of a polyester substrate can be enhanced by exposing a surface of the polyester substrate to a plasma formed from approximately 90% atmospheric air, 5% carbon dioxide, and 5% argon. In another embodiment, contaminants can be removed from the surface of the polyester substrate and the surface energy of the substrate can be increased by exposing the polyester substrate first to an argon plasma etching process and second to a plasma formed from approximately 95% atmospheric air and 5% carbon dioxide.

### CROSS REFERENCE TO RELATED APPLICATIONS

This U.S. Patent Application claims priority under 35 USC 119(e) to U.S. Provisional Patent Application No. 61/617,430 filed Mar. 29, 2012 and entitled “Methods and apparatus for modifying surface energy of laminate stack up” by Michael M. Nikkhoo which is incorporated by reference in its entirety for all purposes.

FIELD OF THE DESCRIBED EMBODIMENTS

The described embodiments relate generally to the manufacturing of consumer electronics and computing devices, and more particularly to providing mechanisms that modify the surface energy of a substrate to facilitate the forming of a bond between disparate materials.

### BACKGROUND

Various manufacturing processes rely on an ability of an adhesive or other bonding agent to securely affix various substances together securely without leaving any gaps between the bonded parts. For example, a depressible key pad can be formed by bonding two flexible substrates together using an adhesive that acts as a spacer. The spacer can separate a set of electrical contacts mounted on the substrates until the key is depressed by a user. Any gaps between the adhesive and the substrates can allow moisture and other substances to come into contact with the electrical contacts. This can adversely affect the ability of the keypad to send an electrical signal to a processor during normal operation.

There are several factors that can affect the ability of a substrate to bond fully with an adhesive. First, the presence of any foreign materials on the exterior of the substrate at the time the adhesive is applied can weaken the bond. The foreign materials can interfere with the ability of the substrate to bond with the adhesive and can create spaces where moisture can seep through the bond. In addition, the “wettability” of a substrate can affect the ability of an adhesive to bond with the substrate. Wettability refers to the relative difference between the surface energies of the substrate and the adhesive. A stronger bond can be formed by ensuring that the surface energy of the substrate exceeds that of the adhesive at the time they are bonded together.

Therefore, what is desired is a method and apparatus for removing foreign materials from the surface of a substrate and raising the surface energy of the substrate in a large scale manufacturing environment.

### SUMMARY OF THE DESCRIBED EMBODIMENTS

This paper describes various embodiments that relate to altering a surface energy of a substrate in a large scale manufacturing environment. In one embodiment, a method for altering a surface energy of a polyester substrate is disclosed. The method includes at least the following steps: (1) providing a plasma formed from a mixture of gasses that includes approximately 90 percent by volume atmospheric air, 5 percent by volume carbon dioxide and 5 percent by volume argon, (2) ejecting the plasma through a nozzle, and (3) moving the polyester substrate through the plasma ejected from the nozzle. The exposure to the plasma can raise the surface energy of the polyester substrate, enhancing the ability of the substrate to bond to an adhesive.

In another embodiment, a different method for altering a surface energy of a polyester substrate is disclosed. The method includes at least the following steps: (1) providing a first plasma formed from argon gas and ejecting the first plasma through a first nozzle, (2) providing a second plasma formed from a mixture of gasses that includes approximately 95 percent by volume atmospheric air and 5 percent by volume carbon dioxide and ejecting the second plasma through a second nozzle, (3) moving the polyester substrate through the first plasma ejected from the first nozzle, and (4) moving the polyester substrate through the second plasma ejected from the second nozzle. The first plasma can remove any contaminants from the surface of the polyester substrate through a plasma etching process and the second plasma can raise the surface energy of the polyester substrate.

In yet another embodiment, a system for removing contaminants from and enhancing a surface activation energy of a polyester substrate is disclosed. The system includes at least the following: (1) three tanks containing atmospheric air, carbon dioxide, and argon, (2) valves regulating the flow of gas from the tanks, (3) a first reactor configured to receive argon from a tank and create a first plasma, (4) a second reactor configured to receive atmospheric air and carbon dioxide from the two remaining tanks and create a second plasma, and (5) a conveyor configured to carry the polyester substrate first through a discharge of the first plasma and second through a discharge of the second plasma.

In still another embodiment, a non-transient computer readable medium for storing computer code executable by a processor in a computer aided manufacturing system for enhancing a surface activation energy of a polyester substrate is disclosed. The computer readable medium includes at least the following: (1) computer code for controlling a valve that directs argon gas from a first tank to a first reactor, (2) computer code for controlling valves that direct atmospheric air and carbon dioxide from a second and third tank respectively to a second reactor, and (3) computer code for controlling the velocity of a conveyor that passes under the first and second reactors.

Other aspects and advantages of the invention will become apparent from the following detailed description taken in conjunction with the accompanying drawings which illustrate, by way of example, the principles of the described embodiments.

### BRIEF DESCRIPTION OF THE DRAWINGS

The described embodiments may be better understood by reference to the following description and the accompanying drawings. Additionally, advantages of the described embodiments may be better understood by reference to the following description and accompanying drawings. These drawings do not limit any changes in form and detail that may be made to the described embodiments. Any such changes do not depart from the spirit and scope of the described embodiments.

FIG. 1 shows an overhead view of two polyester membranes included in a keyboard assembly.

FIG. 2 shows a cross-sectional view of a keyboard assembly.

FIG. 3 shows a cross-sectional view of a surface preparation device.

FIG. 4 shows an isometric view of a surface preparation device including a knife edge nozzle.

FIG. 5 shows a system for raising the surface energy of a substrate in a manufacturing environment.

FIG. 6 shows a flow chart describing a process for increasing the surface energy of a substrate and performing a bonding operation.

FIG. 7 shows a cross-sectional view of a surface preparation device including a plasma etching process.

FIG. 8 shows an isometric view of a surface preparation and etching device including a knife edge nozzle.

FIG. 9 shows a system for removing contaminants from and raising the surface energy of a substrate in a manufacturing environment.

FIG. 10 shows a flow chart describing a process for increasing the surface energy of a substrate and performing a bonding operation.

FIG. 11 shows a block diagram for a controller.

### DETAILED DESCRIPTION OF SELECTED EMBODIMENTS

Representative applications of methods and apparatus according to the present application are described in this section. These examples are being provided solely to add context and aid in the understanding of the described embodiments. It will thus be apparent to one skilled in the art that the described embodiments may be practiced without some or all of these specific details. In other instances, well known process steps have not been described in detail in order to avoid unnecessarily obscuring the described embodiments. Other applications are possible, such that the following examples should not be taken as limiting.

In the following detailed description, references are made to the accompanying drawings, which form a part of the description and in which are shown, by way of illustration, specific embodiments in accordance with the described embodiments. Although these embodiments are described in sufficient detail to enable one skilled in the art to practice the described embodiments, it is understood that these examples are not limiting; such that other embodiments may be used, and changes may be made without departing from the spirit and scope of the described embodiments.

Wetting can be important when bonding two materials together using an adhesive. Wetting refers to an ability of a liquid to maintain contact with a solid surface and results from the intermolecular interactions when the liquid and solid are brought together. There can be two main types of solid surfaces with which liquids can interact. Traditionally, solid surfaces have been divided into high-energy solids and low-energy solids. The relative energy of a solid can depend on the bulk nature of the solid itself. For example, solids such as metals, glasses, and ceramics are typically considered high energy solids because it takes a large input of energy to break the bonds between the individual molecules. Most molecular liquids and adhesives can achieve complete wetting with high-energy surfaces, leading to a high quality bond. On the other hand, solids such as fluorocarbons, hydrocarbons, and polyesters can be considered low-energy solids and can have weaker molecular structures held together primarily by physical forces (e.g., van der Waals and hydrogen bonds). Depending on the type of liquid or adhesive chosen, low-energy surfaces can permit only partial wetting, leading to a lower quality bond.

In general, a lower surface energy adhesive will spontaneously wet out a solid with a higher surface energy surface. Therefore, the quality of an adhesive can be improved by raising the surface energy of a surface on a solid above the surface energy of the adhesive being used. Typically, the surface energy of a solid must exceed the adhesive's surface energy by approximately 2-10 dyne/cm to allow for complete wetting to occur. There are several methods for raising the surface energy of a solid. One method includes treating the surface with a plasma formed from a combination of gasses. Plasma is formed when the molecules within a gas are ionized. When a surface is placed under a plasma discharge, the electrons contained in the ionized plasma can impact the surface with energies approximately two to three times that necessary to break the molecular bonds on the surface of most materials. The resulting free radicals can react rapidly with free radicals on different chains, resulting in cross-links. This can significantly raise the surface energy of the surface, allowing an adhesive to completely wet with the surface and a stronger bond to be formed. The gas or combination of gasses that are ionized to create the plasma can be selected based on the material being treated and the particular application being performed. In one embodiment, a mixture of 90% atmospheric air, 5% argon, and 5% carbon dioxide can be particularly effective at raising the surface energy of substrates made from polyester materials. For the purposes of the present disclosure, the term atmospheric air refers to a gas containing a mixture of approximately 78% nitrogen, 21% oxygen, 1% argon and small amounts of other gasses.

Additionally, the strength of a bond can be increased by removing any impurities or contaminants from bonding surfaces prior to the bonding process. One method of removing these impurities is a plasma etching or plasma cleaning process. Energetic plasma created from a gas such as argon or oxygen can be created by using a high frequency voltage to ionize a low pressure gas. The resulting activated species can include atoms, molecules, ions, electrons, free radicals, and photons in the short wave ultraviolet range. The combination of these elements can be effective in breaking the bonds of most surface contaminants. Moreover, the plasma can be discharged over the surface at a jet velocity sufficiently vaporize and evacuate any contaminants from the area during the cleaning process. In another embodiment, an argon plasma can be particularly effective at removing surface contaminants from the surface of a polyester material during a manufacturing process. In yet another embodiment, an argon plasma treatment can be followed by a surface activation treatment using plasma formed from atmospheric air and carbon dioxide. The combination of techniques can both remove contaminants from the bonding surface as well as raise the surface energy. This can increase wettability and result in a high quality and reliable bond.

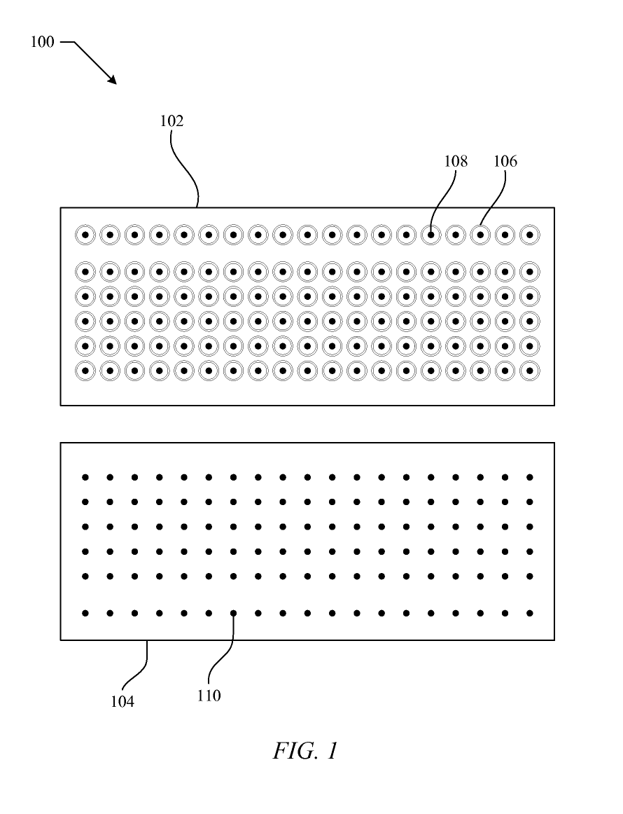

FIG. 1 shows a plan view of polyester membranes 100, demonstrating a possible application of the present disclosure. Upper polyester membrane 102 and lower polyester membrane 104 can be joined to form part of a keyboard. Upper polyester membrane 102 can be printed to include several areas of metal ink 108 and acrylic adhesive 106. Furthermore, lower membrane 104 can be printed to include several areas of metal ink 110 configured to align with metal ink 108 after a bonding operation. In another embodiment, acrylic adhesive 106 can be included on lower polyester membrane 104 instead of upper polyester membrane 102. Moreover, the application of the presently disclosed method to a keyboard assembly is merely an example. One skilled in the art would recognize that the disclosed method can be applied to any process in which a part formed from a polyester substrate is bonded to another part. Therefore, the disclosed method should not be limited to processes involving keyboard assemblies.

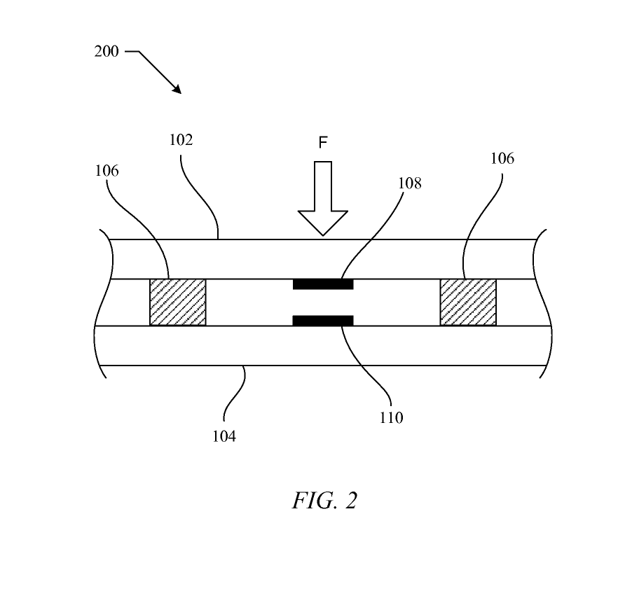

FIG. 2 shows a cross-sectional view of upper polyester membrane 102 and lower polyester membrane 104 after they have been bonded together using acrylic adhesive 106. In another embodiment, an adhesive other than acrylic can be used. For example, silicone or rubber based adhesives can be used in place of acrylic adhesive 106. Metal ink 108 and 110 can be aligned with each other so that when force F is applied to upper polyester membrane 102, metal ink 108 can make contact with metal ink 110. This can send an electronic signal to a computer or other electronic device relaying a user input. Due to the close interaction between a user and a keyboard, polyester membranes 102 and 104 can often come into contact with contaminants such as moisture, dust, or other liquids. Preventing these contaminants from coming into contact with metal ink 108 and 110 can be critical to preventing malfunctions. Therefore, having a high quality bond between polyester membranes 102 and 104 and acrylic adhesive 106 can be advantageous. However, polyester materials can have a low surface energy, preventing an adhesive from fully wetting with a surface of polyester membranes 102 and 104. This can result in a lower quality bond that can allow contaminants such as moisture to bypass acrylic adhesive 106 and interfere with metal ink 108 and 110. Therefore, a method is needed to raise the surface energy of polyester membranes 102 and 104 prior to the bonding operation.

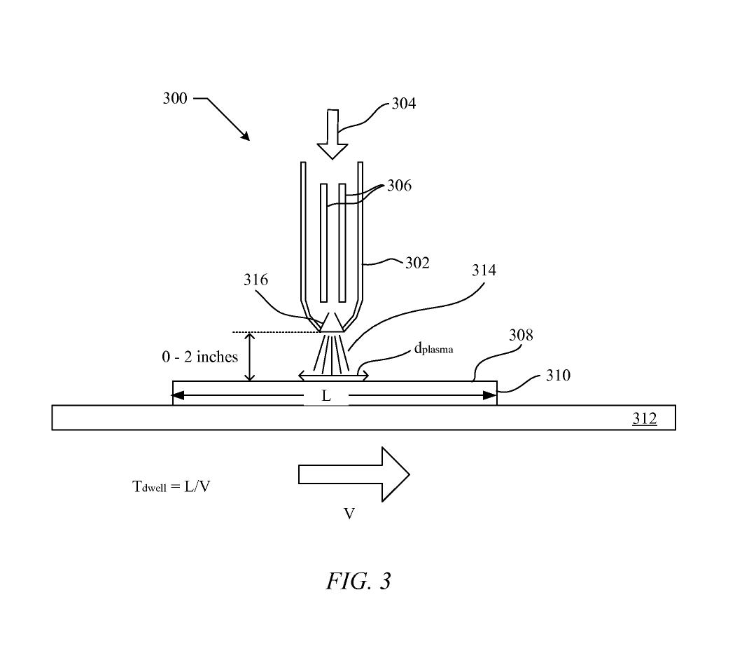

FIG. 3 shows a cross-sectional view of surface preparation device 300, capable of raising the surface energy of a substrate layer such as polyester membranes 102 and 104. Surface preparation device 300 includes reactor 302. Reactor 302 can direct atmospheric gasses 304 through electrodes 306 and out through nozzle 316. In some embodiments, electrodes 306 can apply a voltage difference on the order of several thousand volts. As gasses 304 pass between electrodes 306, molecules within the gasses can become highly ionized, creating plasma 314. Plasma 314 can be directed onto a surface 308 of substrate 310. In one embodiment, substrate 310 can be transported by carrier 312 (such as a conveyor belt) that can move with velocity V. In this way, substrate 310 can be exposed to plasma 314 for a period of time referred to as dwell time that can be on the order of approximately three seconds depending upon the dimension L of surface 308, the dispersal diameter of plasma 314 (dₚₗₐₛₘₐ), and velocity V. In one embodiment, plasma 314 can have a jet speed measured at nozzle 316 in the range of about 1000 fpm to about 2500 fpm and can have a separation distance from surface 108 of about 0.0 to about 2.0 inches.

Gasses 304 that are used to form plasma 314 can include atmospheric air, oxygen, nitrogen or other gasses taken singly or in any combination. In one embodiment, plasma 314 formed from a mixture of approximately 90% atmospheric air, 5% CO₂ and 5% argon can be particularly effective at increasing the surface energy of substrate 310 when substrate 310 is formed from a polyester material. For example, the surface energy of substrate layer 310 can be raised from approximately 40 dynes/cm to approximately 70 dynes/cm. In other embodiments, different combinations of atmospheric gasses such as nitrogen and oxygen can be included in gasses 304. The inclusion of inert gasses with large molecules such as argon can be particularly effective because the larger molecules can etch surface 308 through physical ablation, removing any contaminants while raising the surface energy of substrate 310. The removal of contaminants and increase in surface energy can enhance the ability of substrate 310 to bond with an adhesive such as acrylic.

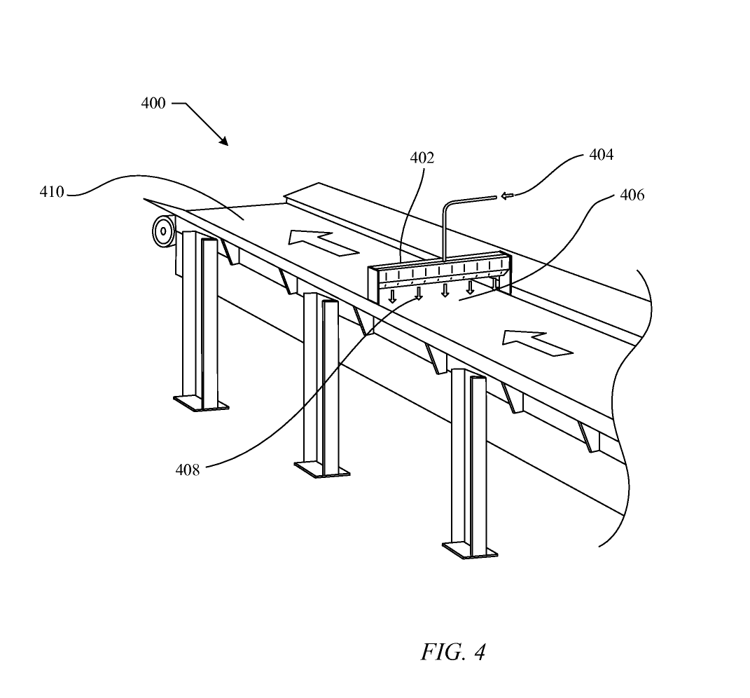

FIG. 4 shows surface preparation device 400, capable of raising the surface energy of a substrate layer such as polyester membranes 102 and 104 in a high volume manufacturing environment. Knife edge nozzle 402 can be configured to provide a uniform jet of plasma 408 across surface activation area 406. In one embodiment, plasma from a reactor can enter through inlet 404 and be distributed across activation area 406 using knife edge nozzle 402. In another embodiment, atmospheric gasses can enter through inlet 404 and knife edge nozzle 402 can include an internal reactor, converting the atmospheric gasses into plasma 408. A substrate or set of substrates can pass under knife edge nozzle 402 while resting on conveyor 410. By adjusting the speed of conveyor 410 and the dispersion rate of knife edge nozzle 402, the dwell time can be adjusted. In one embodiment, a dwell time of approximately three seconds can be sufficient to raise the surface energy of a polyester substrate from approximately 40 dynes/cm to approximately 70 dynes/cm.

As an example, polyester membranes 102 and 104 can be placed on conveyor 410 as part of a manufacturing process. The exposure of polyester membranes 102 and 104 to plasma 408 can raise the surface energy of polyester membranes 102 and 104, allowing for a higher quality bond to be formed in a later operation. In one embodiment, the increase in surface energy from exposure to plasma 408 can last approximately 4-6 hours, allowing ample time between the surface activation process and a later bonding process.

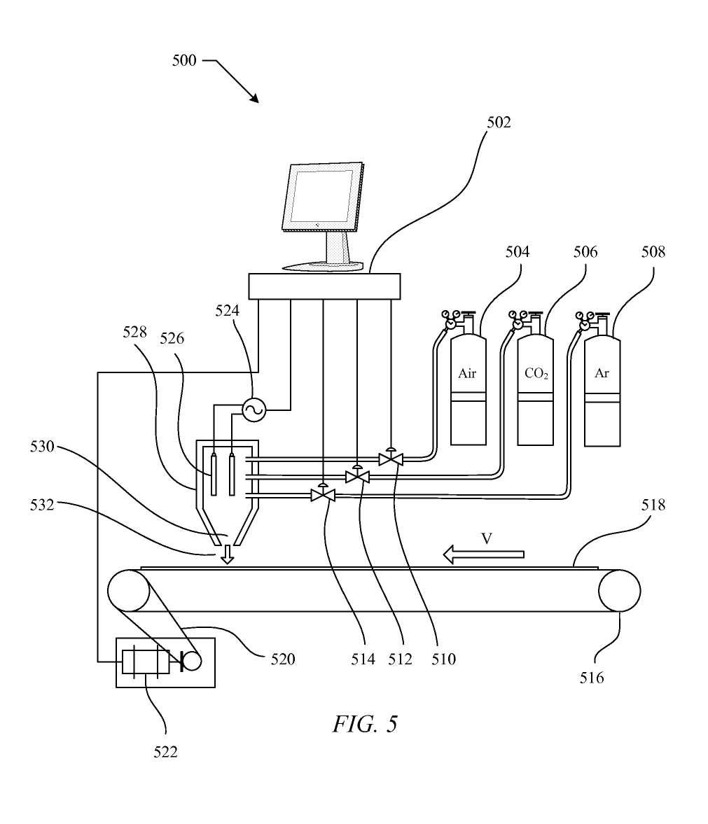

FIG. 5 shows system 500 for raising the surface energy of a substrate in a manufacturing environment. Gasses can be contained in tanks 504, 506, and 508 and connected by hoses to reactor 528. In one embodiment, tank 504 can contain atmospheric air, tank 506 can contain carbon dioxide, and tank 508 can contain argon. The proportions of gasses delivered to reactor 528 from tanks 504, 506, and 508 can be controlled by valves 510, 512, and 514 respectively. In one embodiment, valves 510, 512, and 514 can be automatically controlled by controller 502. In another embodiment, valves 510, 512, and 514 can be adjusted in manually. In still another embodiment, tanks 504, 506, and 508 can be combined into one tank that has been filled with a predetermined mix of gasses. For example, a single tank can contain a mixture of 90% atmospheric air, 5% carbon dioxide, and 5% argon.

Electrodes 526 can be included in reactor 528. AC power source 524 can apply an alternating current to electrodes 526. In one embodiment, the voltage and frequency produced by AC power source 524 can be controlled by controller 502. As gasses from tanks 504, 506, and 508 pass through electrodes 526, the gasses can become highly ionized, creating plasma 532 which can escape through nozzle 530. Nozzle 530 can represent a single nozzle, a plurality of nozzles, a knife edge nozzle, or any other technically feasible means of directing plasma 532. Substrate 518 can rest on conveyor 516 and pass underneath nozzle 530 at velocity V. Electric motor 522 and be coupled to conveyor 516 by pulley 520. Furthermore, the speed of electric motor 522 can be controlled by controller 502, allowing controller 502 to adjust velocity V. By adjusting velocity V, controller 502 can adjust the dwell time for substrate 518. Furthermore, controller 502 can adjust the jet speed at which plasma 532 leaves nozzle 530 by adjusting valves 510, 512, and 514. In one embodiment, sensors can be included in nozzle 530 and conveyor 516 to detect the jet speed and velocity V and send signals relaying this information to controller 502. By adjusting the proportions of gasses, jet speed, and velocity V, controller 502 can optimize the process of increasing the surface energy of substrate 518.

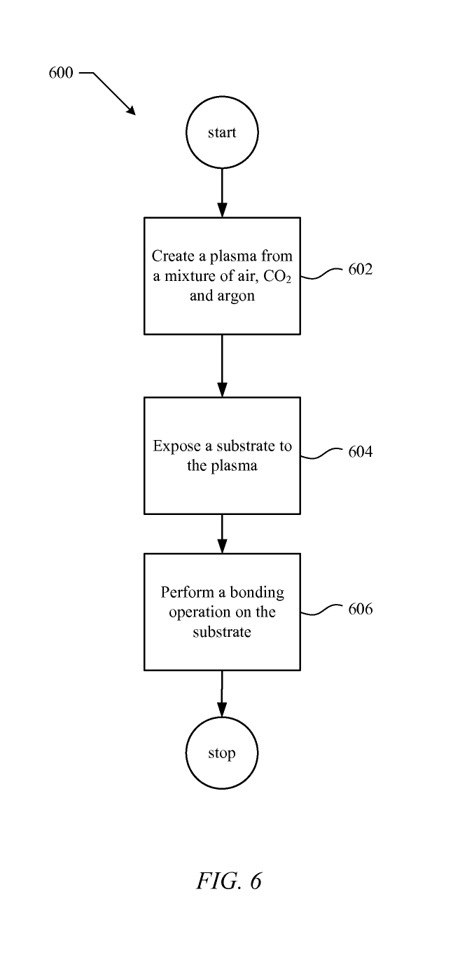

FIG. 6 shows a flowchart detailing process 600 for increasing the surface energy of a substrate and performing a bonding operation in accordance with the described embodiments. In step 602, a plasma can be created from a mixture of approximately 90% atmospheric air, 5% CO₂ and 5% argon. In step 604, a substrate can be exposed to the plasma by passing it under a nozzle ejecting the plasma. The nozzle can include a single nozzle, a plurality of nozzles, or a knife edge nozzle. Furthermore, the nozzle can be positioned approximately 0 to 2 inches above the substrate and can be configured to expel the plasma at approximately 1,000 to 2,500 fpm. Finally, in step 606, a bonding operation can be performed on the substrate. The exposure to the plasma can raise the surface energy of the substrate so that an adhesive can completely wet to the surface of the substrate, resulting in a stronger bond.

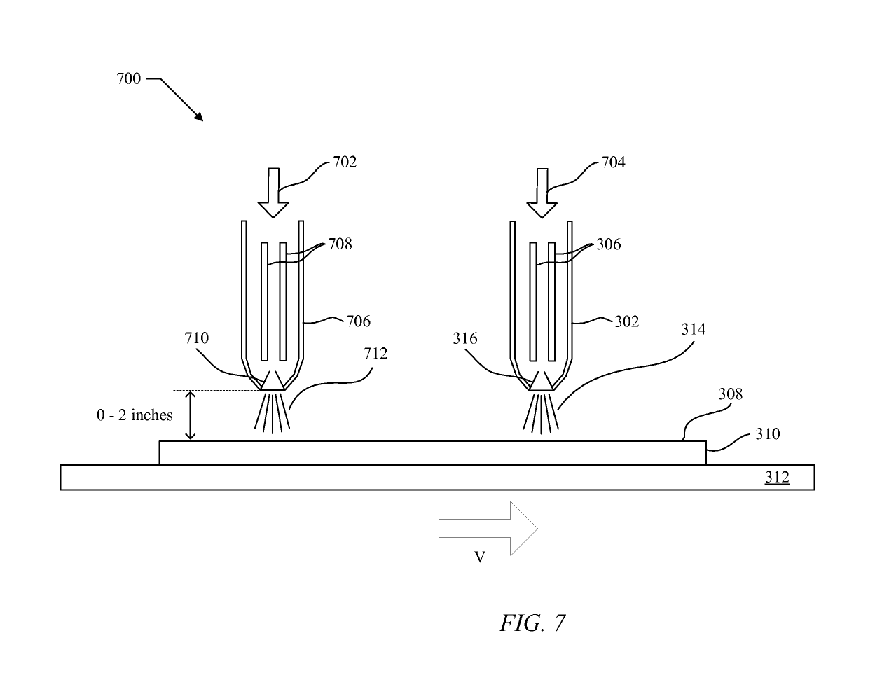

FIG. 7 shows a cross-sectional view of surface preparation device 700, demonstrating another embodiment of the present disclosure that includes pre-process plasma 712. Surface preparation device 700 can include conveyor 312 for transporting substrate 310 at velocity V. Furthermore, surface preparation device 700 can include reactor 302 similar to surface preparation device 300. However, gasses 704 that are used to form plasma 314 can be modified to include a mix of approximately 95% atmospheric air and 5% carbon dioxide.

Additionally, a plasma etching process can be added before the surface activation process carried out by plasma 314. Additional reactor 706 including nozzle 710 can be placed before reactor 302. Gas 702 can enter reactor 706 and pass through electrodes 708. Electrodes 708 can ionize gas 702, creating plasma 712 that can be ejected through nozzle 710. In one embodiment, gas 702 can consist of argon. The large size of argon molecules can make argon particularly effective at etching contaminants away from upper surface 308 of substrate 310. For example, a layer of silicon can sometimes form on top of substrate 310 when substrate 310 is formed from a polyester material. At sufficient velocities, plasma 712 can remove the silicon layer along with any other contaminants through physical ablation. In other embodiments, gasses other than argon with large molecular weights can be used to create plasma 712. Nozzle 710 can be placed approximately 0-2 inches from upper surface 308 of substrate 310, and velocity V can be controlled to allow for a dwell time within plasma 712 of approximately 3 seconds. Furthermore, the jet velocity of plasma 712 through nozzle 710 can be on the order of approximately 1,000 to 2,500 fpm. The combination of the plasma etching process and the plasma surface activation process can further increase the strength of a bond between an adhesive and surface 308.

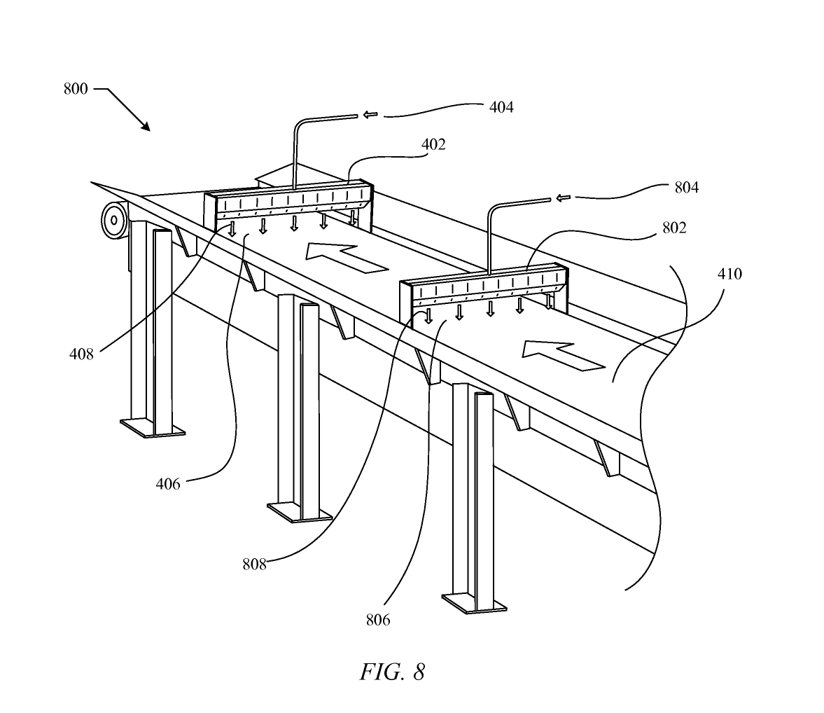

FIG. 8 shows surface preparation device 800, capable of removing contaminants from and raising the surface energy of a substrate layer such as polyester membranes 102 and 104 in a high volume manufacturing environment. Similar to surface preparation device 400, knife edge nozzle 402 can be configured to provide a uniform jet of plasma 408 across surface activation area 406. However, an additional knife edge nozzle 802 can be provided to perform a plasma etching process prior to the surface activation process carried out by knife edge nozzle 402. A plasma formed from a heavy gas such as argon can enter through inlet 804 and be distributed across activation area 806 using knife edge nozzle 802. In another embodiment, gas can enter through inlet 804 and knife edge nozzle 802 can include an internal reactor, converting the gas into plasma 808. As the substrate passes through etching area 806, plasma 808 can remove any contaminants from an upper surface of the substrate by physical ablation. Then, as the substrate passes through surface activation area 406, the surface energy of the upper surface of the substrate can be raised. The combination of the plasma etching process and the plasma surface activation process can increase the strength of a bond between an adhesive and the upper surface of the substrate.

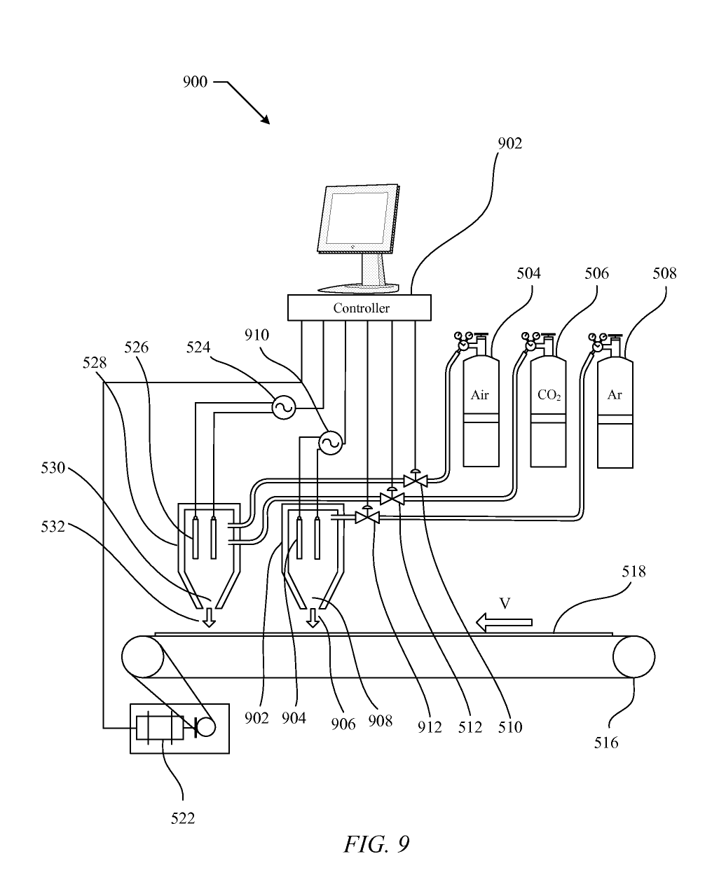

FIG. 9 shows system 900 for removing contaminants from and raising the surface energy of a substrate in a manufacturing environment. Gasses can be contained in tanks 504 and 506 and connected by hoses to reactor 528 for use in a surface activation process. In one embodiment, tank 504 can contain atmospheric air and tank 506 can contain carbon dioxide. The proportions of gasses delivered to reactor 528 from tanks 504 and 506 can be controlled by valves 510 and 512 respectively. In one embodiment, valves 510 and 512 can be automatically controlled by controller 902. In another embodiment, valves 510 and 512 can be adjusted manually. In still another embodiment, tanks 504 and 506 can be combined into one tank that has been filled with a predetermined mix of gasses. For example, a single tank can contain a mixture of 95% atmospheric air and 5% carbon dioxide. Electrodes 526 can be included in reactor 528. AC power source 524 can apply an alternating current to electrodes 526. In one embodiment, the voltage and frequency produced by AC power source 524 can be controlled by controller 902. As gasses from tanks 504 and 506, pass through electrodes 526, the gasses can become highly ionized, creating plasma 532 which can be ejected through nozzle 530 as part of the surface activation process

An additional gas can be contained in tank 508 and connected by a hose to reactor 902 for use in a plasma etching process prior to the surface activation process. In one embodiment, tank 508 can contain argon gas. The amount of argon gas delivered to reactor 902 can be controlled by valve 912. Valve 912 can be controlled either manually or automatically by controller 902. Electrodes 904 can be included in reactor 902. AC power source 910 can apply an alternating current to electrodes 904. In one embodiment, the voltage and frequency produced by AC power source 910 can be controlled by controller 902. As gas from tank 508 passes through electrodes 904, the gas can become highly ionized, creating plasma 906 which can be ejected through nozzle 908 as part of the plasma etching process

Nozzles 530 and 908 can represent a single nozzle, a plurality of nozzles, a knife edge nozzle, or any other technically feasible means of directing plasmas 532 and 906. Substrate 518 can rest on conveyor 516 and pass underneath first nozzle 908, then nozzle 530 at velocity V. Electric motor 522 and be coupled to conveyor 518 and the speed of electric motor 522 can be controlled by controller 902, allowing controller 902 to adjust velocity V. By adjusting velocity V, controller 902 can adjust the dwell time for substrate 518 with respect to both plasma 532 and plasma 906. Furthermore, controller 902 can adjust the jet speed at which plasmas 532 and 906 leave nozzles 530 and 908 respectively by adjusting valves 510, 512, and 912. In one embodiment, sensors can be included in nozzles 530 and 908 and conveyor 516 to detect the jet speeds of plasmas 532 and 906 and velocity V and send signals relaying this information to controller 902. By adjusting the proportions of gasses, jet speed, and velocity V, controller 902 can optimize the plasma etch and surface activation processes for substrate 518.

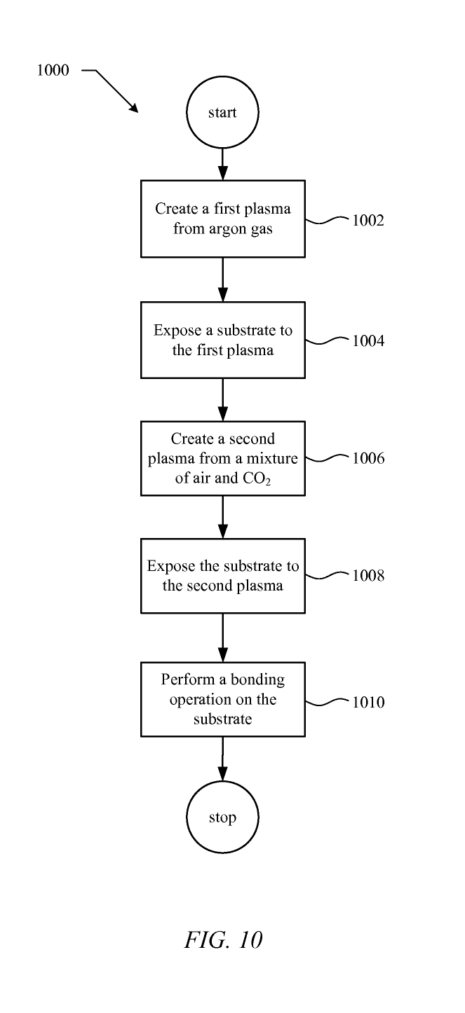

FIG. 10 shows a flowchart detailing process 1000 for removing contaminants from and increasing the surface energy of a substrate in preparation for a bonding operation in accordance with the described embodiments. In step 1002, a first plasma can be created from argon gas. In step 1004, a substrate can be exposed to the argon plasma by passing it under a nozzle. The nozzle can include a single nozzle, a plurality of nozzles, or a knife edge nozzle. Furthermore, the nozzle can be positioned approximately 0 to 2 inches above the substrate and can be configured to expel the plasma at approximately 1,000 to 2,500 fpm. In step 1006, a second plasma can be created from approximately 95% atmospheric air and 5% carbon dioxide. In step 1008, the substrate can be exposed to the second plasma using methods similar to step 1004. Finally, in step 1010, a bonding operation can be performed on the substrate. The exposure to the plasmas can remove contaminants from and raise the surface energy of the substrate so that an adhesive can completely wet to the surface of the substrate, resulting in a stronger bond.

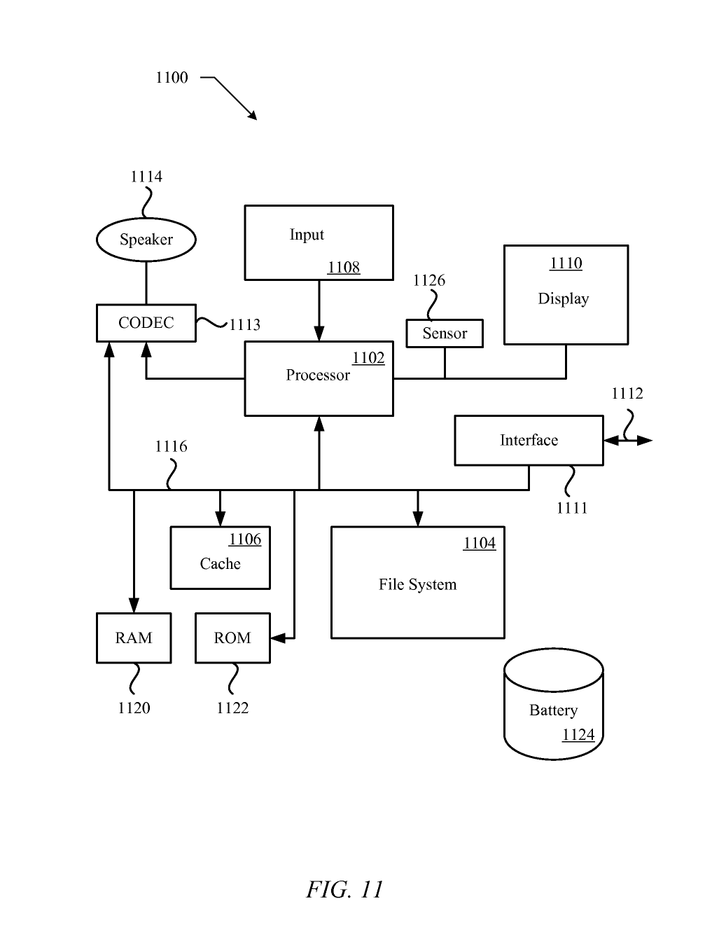

FIG. 11 is a block diagram of electronic controller 1100 suitable for controlling some of the processes in the described embodiment. For example, controller 1100 can represent controller 502 in FIG. 5 or controller 902 in FIG. 9. Controller 1100 illustrates circuitry of a representative computing device. Controller 1100 includes a processor 1102 that pertains to a microprocessor or controller for controlling the overall operation of controller 1100. Controller 1100 contains instruction data pertaining to manufacturing instructions in a file system 1104 and a cache 1106. The file system 1104 is, typically, a storage disk or a plurality of disks. The file system 1104 typically provides high capacity storage capability for the controller 1100. However, since the access time to the file system 1104 is relatively slow, the controller 1100 can also include a cache 1106. The cache 1106 is, for example, Random-Access Memory (RAM) provided by semiconductor memory. The relative access time to the cache 1106 is substantially shorter than for the file system 1104. However, the cache 1106 does not have the large storage capacity of the file system 1104. Further, the file system 1104, when active, consumes more power than does the cache 1106. The power consumption is often a concern when the controller 1100 is a portable device that is powered by a battery 1124. The controller 1100 can also include a RAM 1120 and a Read-Only Memory (ROM) 1122. The ROM 1122 can store programs, utilities or processes to be executed in a non-volatile manner. The RAM 1120 provides volatile data storage, such as for cache 1106.

The controller 1100 also includes a user input device 1108 that allows a user of the controller 1100 to interact with the controller 1100. For example, the user input device 1108 can take a variety of forms, such as a button, keypad, dial, touch screen, audio input interface, visual/image capture input interface, input in the form of sensor data, etc. Still further, the controller 1100 includes a display 1110 (screen display) that can be controlled by the processor 1102 to display information to the user. A data bus 1116 can facilitate data transfer between at least the file system 1104, the cache 1106, the processor 1102, and a CODEC 1113. The CODEC 1113 can be used to decode and play a plurality of media items from file system 1104 that can correspond to certain activities taking place during a particular manufacturing process. The processor 1102, upon a certain manufacturing event occurring, supplies the media data (e.g., audio file) for the particular media item to a coder/decoder (CODEC) 1113. The CODEC 1113 then produces analog output signals for a speaker 1114. The speaker 1114 can be a speaker internal or external to the controller 1100. For example, headphones or earphones that connect to the controller 1100 would be considered an external speaker.

The controller 1100 also includes a network/bus interface 1111 that couples to a data link 1112. The data link 1112 allows the controller 1100 to couple to a host computer or to accessory devices. The data link 1112 can be provided over a wired connection or a wireless connection. In the case of a wireless connection, the network/bus interface 1111 can include a wireless transceiver. The media items can be any combination of audio, graphical or visual content. Sensor 1126 can take the form of circuitry for detecting any number of stimuli. For example, sensor 1126 can include any number of sensors for monitoring a manufacturing operation such as for example a Hall Effect sensor responsive to external magnetic field, an audio sensor, a light sensor such as a photometer, and so on.

The various aspects, embodiments, implementations or features of the described embodiments can be used separately or in any combination. Various aspects of the described embodiments can be implemented by software, hardware or a combination of hardware and software. The described embodiments can also be embodied as computer readable code on a computer readable medium for controlling manufacturing operations or as computer readable code on a computer readable medium for controlling a manufacturing line. The computer readable medium is any data storage device that can store data which can thereafter be read by a computer system. Examples of the computer readable medium include read-only memory, random-access memory, CD-ROMs, HDDs, DVDs, magnetic tape, and optical data storage devices. The computer readable medium can also be distributed over network-coupled computer systems so that the computer readable code is stored and executed in a distributed fashion.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of specific embodiments are presented for purposes of illustration and description. They are not intended to be exhaustive or to limit the described embodiments to the precise forms disclosed. It will be apparent to one of ordinary skill in the art that many modifications and variations are possible in view of the above teachings.

What is claimed is:

1. A method for enhancing a surface activation energy of a polyester substrate, the method comprising:
providing a plasma, the plasma formed of a mixture of gasses that includes approximately 90 percent by volume atmospheric air, 5 percent by volume carbon dioxide and 5 percent by volume argon;
ejecting the plasma through a nozzle; and
moving the polyester substrate through the plasma ejected from the nozzle.

2. The method as recited in claim 1, wherein the plasma substrate is exposed to the plasma for a dwell time of approximately 3-6 seconds.

3. The method as recited in claim 2, wherein the plasma is ejected from the nozzle at a velocity in a range from about 1000 ft/min to about 2500 ft/min.

4. The method as recited in claim 3, wherein a distance between the nozzle and the polyester substrate is within a range from about 0.0 in to 2.0 in.

5. The method as recited in claim 4, wherein a plurality of nozzles are provided to eject plasma over a large area of the polyester substrate.

6. The method as recited in claim 4, wherein a knife edge nozzle is provided to eject plasma over a large area of the polyester substrate.

7. A method for removing contaminants from and enhancing a surface activation energy of a polyester substrate, the method comprising:
providing a first plasma formed from argon gas, wherein the first plasma is ejected through a first nozzle;
providing a second plasma formed from a mixture of gasses that includes approximately 95 percent by volume atmospheric air and 5 percent by volume carbon dioxide, wherein the second plasma is ejected through a second nozzle;
moving the polyester substrate through the first plasma ejected from the first nozzle; and
moving the polyester substrate through the second plasma ejected from the second nozzle.

8. The method as recited in claim 7, wherein the first and second plasmas are both ejected from the first and second nozzles at a velocity in a range from about 1000 ft/min to about 2500 ft/min.

9. The method as recited in claim 8, wherein a distance between each of the first and second nozzles and the polyester substrate is within a range from about 0.0 in to 2.0 in.

10. The method as recited in claim 9, wherein the plasma substrate is exposed to both the first plasma and the second plasma for a dwell time of approximately 3-6 seconds each.

11. The method as recited in claim 10, wherein the first nozzle further comprises plurality of nozzles provided to eject plasma over a large area of the polyester substrate.

12. The method as recited in claim 11, wherein the second nozzle further comprises plurality of nozzles provided to eject plasma over a large area of the polyester substrate.

13. The method as recited in claim 10, wherein both the first and second nozzle further comprise a knife edge nozzle configured to eject the first and second plasmas over a large area of the polyester substrate.

14. A system for removing contaminants from and enhancing a surface activation energy of a polyester substrate, the system comprising:
a first tank containing atmospheric air;
a second tank containing carbon dioxide;
a third tank containing argon;
a first valve, a second valve, and a third valve configured to regulate a flow of gas from the first tank, second tank, and third tank respectively;
a first reactor configured to receive argon from the third tank, wherein the first reactor includes electrodes for converting the argon into a first plasma and a nozzle for directing the first plasma;
a second reactor configured to receive the atmospheric air and the carbon dioxide from the first and second tanks respectively, wherein the second reactor includes electrodes for converting the atmospheric air and the carbon dioxide into a second plasma and a nozzle for directing the second plasma;
a conveyor configured to carry the polyester substrate first through a discharge of the first plasma and second through a discharge of the second plasma, wherein the first plasma removes contaminants from a surface of the polyester substrate and the second plasma enhances the surface energy of the polyester substrate.

15. The system as recited in claim 14 further comprising a controller, wherein the controller automatically adjusts the first second and third valves to maintain a predetermined first jet velocity representing the velocity at which the first plasma exits the first nozzle and a predetermined second jet velocity representing the velocity at which the second plasma exits the second nozzle.

16. The system as recited in claim 15, wherein the predetermined first jet speed and predetermined second jet speed are both velocities in a range from approximately 1000 ft/min to approximately 2500 ft/min.

17. The system as recited in claim 14, wherein the controller controls the speed of the conveyor, allowing the controller to maintain a predetermined dwell time.

18. The system as recited in claim 17, wherein the predetermined dwell time is approximately 3-6 seconds.

19. A non-transient computer readable medium for storing computer code executable by a processor in a computer aided manufacturing system for removing contaminants from and enhancing a surface activation energy of a polyester substrate, comprising:
computer code for controlling a valve that directs argon gas from a first tank to a first reactor;
computer code for controlling valves that direct atmospheric air and carbon dioxide from a second and third tank respectively to a second reactor; and
computer code for controlling the velocity of a conveyor that passes under the first and second reactors.

20. The non-transient computer readable medium as recited in claim 19, further comprising computer code for controlling the voltage and frequency of electrodes contained within the first and second reactors.

21. The non-transient computer readable medium as recited in claim 20 further comprising computer code for interpreting inputs from sensors configured to detect a first velocity of a first plasma exiting the first reactor and a second velocity of a second plasma exiting the second reactor.
